(19) United States
(12) Patent Application Publication
(10) Pub. No.: US 2005/0014672 A1
(43) Pub. Date: Jan. 20, 2005

(54) Rinse aid additive and composition containing same

(76) Inventor: Shoaib Arif, Dublin, OH (US)

Correspondence Address: Leopold Presser, Scully, Scott, Murphy & Presser, 400 Garden City Plaza, Garden City, NY, 11530, US

(21) Appl. No.: 10/622,281

(22) Filed: Jul. 18, 2003

(51) Int. Cl. C11D 1/00

(52) U.S. Cl. 510/504

(57) ABSTRACT

The present invention is directed to a rinse aid additive, and rinse aid compositions containing the additive. The additive includes an amidoamine quaternary ammonium component derived from a non-animal source; a first primary amine ethoxylate derived from a non-animal source; and a second primary amine ethoxylate derived from an animal source.

### FIELD OF THE INVENTION

The present invention relates to rinse aid additives and compositions containing same that, when such a composition is applied to a wetted surface, facilitates the drying thereof. Such compositions are employed, for example, in automated motor vehicle washing operations.

### BACKGROUND OF THE INVENTION

Rinse aids have found application in automated motor vehicle washing operations, such as in commercial car washes, as a facilitator of the drying of a wetted surface.

In a car wash, a vehicle is moved though a number of stations in which the steps of washing the vehicle are carried out in an automated process. Among other process steps, water is sprayed onto the vehicle. A cleaning agent, which may be in the form of lather or foam, is deposited onto the vehicle. The vehicle is passed through rotating brushes and/or a ribboned curtain to rub and move the soap over the body of the vehicle, and the vehicle is rinsed to remove the cleaning agent. A rinsing agent may be applied during the rinsing step (or in a subsequent step) in order to facilitate the drying of the vehicle. The rinse agent contributes to reducing the amount of water on the surface of the car and thus helps dry the car faster by causing the water to bead and sheet off the car.

An aqueous composition containing mineral seal oil, that is, deodorized kerosene and paraffin, has been employed as a rinse aid.

### SUMMARY OF THE INVENTION

In one aspect, the present invention is an additive suitable for use in a rinse aid composition that can be employed in an automated motor vehicle washing operation, such as a car wash, or in an automotive detail shop, or in the washing of a car at home, or in another processes or operations where rapid drying of a wetted object is desired. The rinse aid additive is comprised of a composition including an amidoamine quaternary ammonium component derived from a animal and non-animal sources, and at least one non-ionic surfactant, such as for example, a non-ionic surfactant selected from among primary amine ethoxylates, alkylphenol ethoxylates, alcohol ethoxylates, fatty acid esters, sorbitan esters, ethoxylated sorbitan esters, and alkyl polyglucoside ethoxylates. In one aspect, the present invention is an additive suitable for use in a rinse aid composition comprised of a composition including an amidoamine quaternary ammonium component derived from animal and non-animal sources, a first primary amine ethoxylate derived from non-animal sources, such as coconut, and a second primary amine ethoxylate derived from animal sources, such as tallow. In a specific embodiment of the present invention, the additive includes an amidoamine quaternary ammonium component derived from soybean oil, a first primary amine ethoxylate derived from coconut oil, and a second primary amine ethoxylate derived from tallow.

In another aspect of the invention, the additive described above is incorporated in a rinse aid composition in the form of an oil-in-water microemulsion. By “microemulsion”, it is meant that the suspended oil droplets are of a size sufficiently small so that the microemulsion is substantially clear. In a more specific embodiment of the present invention, the rinse aid composition includes the rinse aid additive described above, at least one hydrophobic component, such as a hydrophobic component selected from mineral seal oil, ethyl oleate, octyl palmitate, ethyl ester of oleic acid, soybean oil, coconut oil, isopropyl palmitate, isopropyl mystearate, and other fatty acid esters, and at least one glycol ether such as propylene glycol monobutyl ether, ethylene glycol monobutyl ether, dipropylene glycol monobutyl ether, diethylene glycol monomethyl ether, triethylene glycol monomethyl ether, diethylene glycol monoethyl ether, triethylene glycol monoethyl ether, ethylene glycol monopropyl ether, propylene glycol methyl ether, dipropylene glycol methyl ether, tripropylene glycol methyl ether, propylene glycol methyl ether acetate, dipropylene glycol methyl ether acetate, to name a few examples thereof.

The amidoamine quaternary ammonium component employed in the additives and compositions of the present invention can be derived from animal and non-animal sources, such as, merely by way of example tallow, soybean, oleic, palmitic, canola, and coconut.

The rinse aid of the present invention can be diluted with water to provide a final rinse aid composition that is applied at the automated motor vehicle washing facility, in order to facilitate water removal from a motor vehicle.

### DETAILED DESCRIPTION OF THE INVENTION

The rinse aid composition of the present invention includes an amidoamine quaternary ammonium component derived from a non-animal source. A suitable amidoamine quaternary ammonium compound has the following formula I: 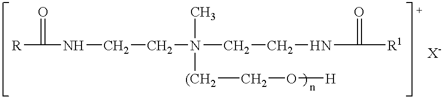
where R and R¹ independently from each other are a hydrocarbon group of about 5 to about 25, preferably 11 to 18 carbon atoms in length, having saturated and unsaturated bonds, and is derived from animal or non-animal source, such as, merely by way of example, tallow, soybean, oleic, palmitic, canola, and coconut; n is a number between 1 and 10, preferably 1 to 5, X is a suitable organic or inorganic anion, such as an anion selected from the group consisting of chloride, sulfate, acetate, propionate, formate, gluconate, methyl sulfate, and ethyl sulfate. In one embodiment, the hydrocarbon group of the amidoamine is derived from soybean oil, and is about 12 to 18 carbon atoms in length.

VARISOFT® 222 SB 90, available from the Goldschmidt Chemical Company, Hopewell Va., a commercially available ethoxylated amidoamine quaternary ammonium compound based on soybean oil, has been found to be suited for incorporation in the rinse aid additive of the present invention.

Other suitable amidoamine quaternary ammonium compounds include VARISOFT® 222 LM 90, derived from a tallow source, VARISOFT® 110 75, also derived from a tallow source, and VARISOFT® 222 LT 90, derived from an oleic source. VARISOFT® 222 LM 90, VARISOFT® 110 75, and VARISOFT® 222 LT 90 are available from the Goldschmidt Chemical Company. VARISOFT® amidoamine quaternary ammonium compounds include an amount of carrier, such as a glycol or an alcohol carrier.

The rinse aid additive of the present invention also includes a nonionic surfactant such as primary amine ethoxylates, alkylphenol ethoxylates, alcohol ethoxylates, fatty acid esters, sorbitan esters, ethoxylated sorbitan esters, and alkyl polyglucoside ethoxylates. In one specific embodiment, the rinse aid composition includes a first primary amine ethoxylate derived from a non-animal source and a second primary amine ethoxylate derived from an animal source. Particular first and second primary amine ethoxylates are respectively derived from coconut oil and tallow, and have the following formula II:
R-[N(CH₂—CH₂O)ₓH]₂ II

Where R is a hydrocarbon group containing 6 to 22 carbon atoms containing saturated and unsaturated bonds; and
x=2 to 25, preferably 2 to 15.

A suitable commercially available primary amine ethoxylate derived from coconut oil is VARONIC® K-205 Other suitable sources for the primary ethoxylated amine include oleic, stearic, palmitic, canola, and soybean, to name a few examples.

A suitable commercially available primary amine ethoxylate derived from an animal source, such as tallow is VARONIC® T-210.

VARONIC® K-205 and VARONIC® T-210 are also available from the Goldschimdt Chemical Company, Hopewell, Va.

Suitable alkylphenol ethoxylates include those formulated with 6 to 12 moles ethylene oxide. Nonylphenol ethoxylates, octylphenol ethoxylates, dinonylphenol ethoxylates are a few examples of alkylphenol ethoxylates. In one specific embodiment, a nonylphenol ethoxylate formulated with 9 moles of ethylene oxide is employed. A suitable nonylphenol ethoxylate is available under the Tradename IGEPAL® CO-630 available from Rhodia, Inc., Cranbury N.J. Nonylphenol ethoxylates are also available from Huntsman under the tradenames SURFONIC ® N and TERIC® N.

Suitable alcohol ethoxylates include those with hydrocarbon chains of about 9 to 18 carbon atoms formulated with 2.5 to 6 moles ethylene oxide. Alcohol ethoxylates are available under the TOMAHDOL® Tradename from Tomah Products, Inc., Milton Wis.

Ethoxylated fatty acid esters, PEG esters, and ethoxylated sorbitan esters are available from Rhodia, Inc. of Cranbury N.J. Sorbitan ester ethoxylates are also available from Sigma-Aldrich under the TWEEN tradename, Sorbitan ester ethoxylates are also available from Goldschmidt GmbH under the TEGO SMO and TEGO SMS trade names. Alkylpolyglucosides are available from Cognis.

On a weight-weight basis, the amidoamine quaternary ammonium compound is present in the rinse aid additive in amount of about 90% to about 10%, preferably about 75% to about 25%, the balance being the non-ionic surfactant or surfactants. More preferably, the amidoamine quaternary ammonium compound is present in the additive in an amount of about 50%, with the balance being nonionic surfactant(s).

The rinse aid additive of the present invention is formulated in a rinse aid composition that is an oil-in-water microemulsion. The rinse aid composition includes the rinse aid additive described above, at least one hydrophobic component, such as a hydrophobic component selected from mineral seal oil, ethyl oleate, octyl palmitate, ethyl ester of oleic acid, soybean oil, coconut oil, isopropyl palmitate, isopropyl mystearate, and other fatty acid esters, and at least one glycol ether such as propylene glycol monobutyl ether, ethylene glycol monobutyl ether, dipropylene glycol monobutyl ether, diethylene glycol monomethyl ether, triethylene glycol monomethyl ether, diethylene glycol monoethyl ether, triethylene glycol monoethyl ether, ethylene glycol monopropyl ether, propylene glycol methyl ether, dipropylene glycol methyl ether, tripropylene glycol methyl ether, propylene glycol methyl ether acetate, dipropylene glycol methyl ether acetate, to name a few examples thereof.

One suitable composition includes, on a weight-weight basis, 5 to 50%, preferably 15 to 25% additive (which includes, on a weight-weight basis 60 to 90%, preferably 70 to 80%, VARISOFT® 222 SB 90, 10 to 40%, preferably 15 to 25% of at least one ethoxylated fatty amine) 10 to 30, preferably 15 to 25% % mineral seal oil, 1 to 9%, preferably 4 to 6% glycol ether, and ad 100% water. The composition can be produced by mixing the components with mechanical mixers, such as a lightning mixer. The components are placed in a mixing for a time sufficient to produce a clear microemulsion. Mixing steps may be carried out for a duration of about 30 to about 60 minutes.

One suitable composition includes, on a weight-weight basis, 20.0% additive (which includes, on a weight-weight basis 75.0% VARISOFT® 222 SB 90, 12.5% VARONIC® K-205, and 12.5% VARONIC® T-210) 25.0% mineral seal oil, 5.0% glycol ether, and 50.0% water. The composition can be produced by mixing the components with mechanical mixers, such as a lightning mixer. The components are placed in a mixing for a time sufficient to produce a clear microemulsion. Mixing steps may be carried out for a duration of about 30 to about 60 minutes.

The concentrated microemulsion is readily prepared by combining the indicated ingredients, and subjecting the combination to high shear agitation effective to establish a stable microemulsion. The clarity of the microemulsion contributes to the aesthetic attractiveness of the product before use and after application to the surface which is to be rendered hydrophobic, and also indicates stability of the microemulsion. The microemulsion is characterized by clarity, stability (by which is meant resistance to separate into noticeably separated aqueous and non-aqueous phases), and by relatively low polydisperity. In addition the microemulsion can readily be diluted with tap water to a more dilute form. Prior to use, such as in an automated car wash, the rinse aid composition may be diluted with water to a concentration of about 1:500 to about 1:1000 (w/w).

The concentrated microemulsion is readily prepared by combining the indicated ingredients, and subjecting the combination to high shear agitation effective to establish a stable microemulsion. It is preferred that the oil component be selected such that the microemulsion can readily be formed and such that concentrate upon formation is transparent or translucent and not hazy. The clarity of the microemulsion contributes to the aesthetic attractiveness of the product before use and after application to the surface which is to be rendered hydrophobic, and also indicates the longer stability of the microemulsion. The microemulsion is characterized by clarity, stability (by which is meant resistance to separate into noticeably separated aqueous and non-aqueous phases), and by relatively low polydisperity. In addition the microemulsion can readily be diluted with tap water to form a more dilute form, which may undergo some loss of clarity.

### EXAMPLE

A rinse aid additive was formulated as follows:

| Ingredients | % (w/w) |
|---|---|
| VARISOFT ® 222 SB 90 | 75.0 |
| VARONIC ® K-205 | 12.5 |
| VARONIC ® T-210 | 12.5 |

With continuous mixing, the ingredients were added in the order listed. Mixing continued until the additive appeared to be clear, homogeneous, and free of lumps and particles.

The inventive additive, as shown in the Example, was then formed into a microemulsion containing mineral seal oil, glycol ether, and water, in the following proportions, on a weight-weight basis. For comparative purposes, a microemulsion containing a commercially available additive on basis of dicocodimethyl ammonium quaternary product, where two hydrocarbon groups are derived from coconut sources was also prepared.

| | |
|---|---|
| Comparative/Example | 20.0 |
| Mineral Seal Oil | 25.0 |
| Glycol Ether | 5.0 |
| Water | 50.0 |

1 gm of each microemulsion is placed in a 1000 ml beaker and 499 gms. of cold tap water are added to each beaker. The mixtures are stirred for 5 minutes with a magnetic stirrer or until homogenous.

Dawn Dishwashing soap is placed on a 3″ X 12″ painted metal panel and the panel is rubbed with gloved hands for 30 seconds. The panel is rinsed under tap water for 30 seconds, then inspected to ascertain that all the soap is completely washed off the panel.

Next, 100 ml of the compositions containing the additives Example and Comparative are sprayed on the panel to cover the entire surface of the panel. The panel is then placed under cold tap water and rinsed for 10 seconds. The panel and placed vertically to dry. The time for all the water to sheet off the panel is measured and recorded.

Drying Time Test Results: (Seconds) 1:500 Dilution

| | | | | | |
|---|---|---|---|---|---|
| Comparative | 13 | 13 | 16 | 17 | 15 |
| Example | 9 | 8 | 8 | 9 | 9 |

As can be seen, the drying time is decreased considerably which means efficiency in automated motor vehicle washing operations is improved.

Stability

The rinse aid composition containing additive of the example showed stability over three months in the following conditions:

| | |
|---|---|
| Room Temp. | Stable |
| 40 C. Oven | Stable |
| 40 F. Fridge | Stable |
| Freeze Thaw | Stable |

1) A rinse aid additive for incorporation in a composition for facilitating the drying of a wetted surface, the additive comprised of:
a. An amidoamine quaternary ammonium component derived from an animal or non-animal source;
b. At least one surfactant selected from the group consisting of primary amine ethoxylates, alkylphenol ethoxylates, alcohol ethoxylates, fatty acid esters, sorbitan esters, ethoxylated sorbitan esters, alkyl polyglucoside ethoxylates, and mixtures thereof,
wherein components (a) and (b) are present in amounts effective to facilitate the removal of water from a wetted surface.

2) The rinse aid additive of claim 1 wherein the amidoamine quaternary ammonium component is derived from a source selected from the group consisting of tallow, soybean, canola, oleic, palmitic, stearic, and coconut.

3) The rinse aid additive of claim 1 wherein the surfactant is a nonylphenol ethoxylate formulated with 6 to 12 moles ethylene oxide.

4) The rinse aid additive of claim 1 wherein the surfactant is a C₉ to C₁₈ alcohol ethoxylate formulated with 2.5 to 6 moles ethylene oxide.

5) A rinse aid additive for incorporation in a composition for facilitating the drying of a wetted surface, the additive comprised of:
a. An amidoamine quaternary ammonium component derived from an animal or non-animal source;
b. A first primary amine ethoxylate derived from a non-animal source; and
c. A second primary amine ethoxylate derived from an animal source;
wherein components (a) (b) and (c) are present in amounts effective to facilitate the removal of water from a wetted surface.

6) The additive of claim 5 wherein the amidoamine quaternary ammonium component is derived from a source selected from sources selected from the group consisting of tallow, soybean, canola, oleic, palmitic, stearic, and coconut.

7) The additive of claim 5 wherein first ethoxylated amine component is derived from a source selected from the group consisting of coconut, palmitic, canola, oleic, and stearic.

8) The additive of claim 5 wherein the amidoamine quaternary ammonium compound is derived from soybean oil.

9) The additive of claim 8 wherein the amidoamine quaternary ammonium compound has a chemical structure corresponding to chemical formula I 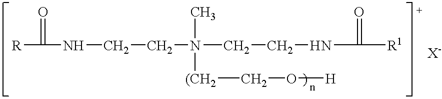
where R and R¹ independently from each other are hydrocarbon groups of about 11 to about 17 carbon atoms in length, having saturated and unsaturated bonds, n is a number between 1 and 10, and X is an organic or inorganic anion, such as an anion selected from the group consisting of chloride, sulfate, acetate, propionate, formate, gluconate, methyl sulfate, and ethyl sulfate.

10) The additive of claim 5 wherein the first and second primary amine ethoxylates have a structure corresponding to chemical formula II
R²-[N(CH₂—CH₂O)ₓH]₂
Wherein R is a hydrocarbon group of about 6 to 22 carbon atoms and x=2 to 25.

11) The additive of claim 8 wherein the first and second primary amine ethoxylates have a structure corresponding to chemical formula II
R²— [N(CH₂—CH₂O)ₓ H]₂
Wherein R is a hydrocarbon group of about 6 to 22 carbon atoms and x=2 to 25.

12) The additive of claim 10 wherein the first primary amine exthoxylate is derived from a coconut source and x=5.

13) The additive of claim 11 wherein the first primary amine exthoxylate is derived from a coconut source and x=5.

14) The additive of claim 10 wherein the second primary amine exthoxylate is derived from tallow and x=10.

15) The additive of claim 11 wherein the second primary amine exthoxylate is derived from tallow and x=10.

16) The additive of claim 12 wherein the second primary amine exthoxylate is derived from tallow and x=10.

17) The additive of claim 13 wherein the second primary amine exthoxylate is derived from tallow and x=10.

18) The additive of claim 5 wherein, on a weight-weight basis, component (a) is present in the additive in an amount of from about 90% to about 10%.

19) A rinse aid additive for incorporation in a composition for facilitating the drying of a wetted surface, the additive comprised of:
a) an amidoamine quaternary ammonium component derived from soybean oil having a chemical structure corresponding to chemical formula I 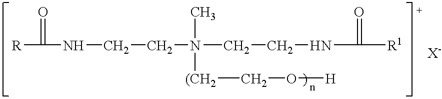
where R and R¹ independently from each other are hydrocarbon groups of about 11 to about 17 carbon atoms in length, having saturated and unsaturated bonds, n is a number between 1 and 10, and X is an organic or inorganic anion, such as an anion selected from the group consisting of chloride, sulfate, acetate, propionate, formate, gluconate, methyl sulfate, and ethyl sulfate, and
b) first and second primary amine ethoxylates having a structure corresponding to chemical formula II
R²-[N(CH₂—CH₂O)ₓH]₂
Wherein R is a hydrocarbon group of about 6 to 22 carbon atoms and x=2 to 25.

20) The additive of claim 19 wherein the first primary amine exthoxylate is derived from a coconut source and x=5.

21) The additive of claim 19 wherein the second primary amine exthoxylate is derived from tallow and x=10.

22) The additive of claim 20 wherein the second primary amine exthoxylate is derived from tallow and x=10.

23) A rinse aid composition for facilitating the removal of water from a wetted surface comprised of the additive of claim 1, at least one hydrophobic component, at least one glycol ether, and water, wherein said composition is a microemulsion.

24) A rinse aid composition for facilitating the removal of water from a wetted surface comprised of the additive of claim 5, at least one hydrophobic component, at least one glycol ether, and water, wherein said composition is a microemulsion.

25) The rinse aid composition of claim 24 in a concentration, on a weight-weight basis, of about 1:500 to 1:1000.

26) A rinse aid composition for facilitating the removal of water from a wetted surface comprised of the additive of claim 8, at least one hydrophobic component, at least one glycol ether, and water, wherein said composition is a microemulsion.

27) The rinse aid composition of claim 26 in a concentration, on a weight-weight basis, of about 1:500 to 1:1000.

28) A rinse aid composition for facilitating the removal of water from a wetted surface comprised of the additive of claim 17, at least one hydrophobic component, at least one glycol ether, and water, wherein said composition is a microemulsion.

29) The rinse aid composition of claim 28 in a concentration, on a weight-weight basis, of about 1:500 to 1:1000.

30) A rinse aid composition for facilitating the removal of water from a wetted surface comprised of the additive of claim 19, at least one hydrophobic component, at least one glycol ether, and water, wherein said composition is a microemulsion.

31) The rinse aid composition of claim 30 in a concentration, on a weight-weight basis, of about 1:500 to 1:1000.

32) A rinse aid composition for facilitating the removal of water from a wetted surface comprised of the additive of claim 23, at least one hydrophobic component, at least one glycol ether, and water, wherein said composition is a microemulsion.

33) The rinse aid composition of claim 32 in a concentration, on a weight-weight basis, of about 1:500 to 1:1000.
